(19) United States
(12) Patent Application Publication
(10) Pub. No.: US 2012/0188710 A1
(43) Pub. Date: Jul. 26, 2012

(54) LATCH FOR A RACK MOUNTED DEVICE

(76) Inventors: Andrew James Phelan, Magnolia, TX (US); John P. Franz, Houston, TX (US); Minh H. Nguyen, Katy, TX (US)

(21) Appl. No.: 13/012,521

(22) Filed: Jan. 24, 2011

(51) Int. Cl. G06F 1/16; F16B 5/06

(52) U.S. Cl. 361/679.58; 403/322.4

(57) ABSTRACT

A latch for holding a rack mounted device into a rack is disclosed. The latch is formed from an essentially flat plate. The latch has an attachment section used to attach the latch to the rack mounted device. A serpentine section is formed adjacent to the attachment section. A beam section extends at an angle from the serpentine section. A head is attached to the end of the beam. The head has a catch that extends from the edge of the beam by a distance X, where X is in the plane of the flat plate. The serpentine section allows the head to be deflected by distance X where the deflection is in the plane of the flat plate.

### BACKGROUND

Servers are getting denser with more components place on each device or blade. As the density increases the weight of the blades or devices has also increased. Blades and other devices are typically slid into a rack or chassis. Once the device has been inserted into the chassis a latch holds the device in place. As the devices increase in weight, the demands placed on the latch have increased. The increase in density has also limited the space allowed for the latch that holds the devices into the chassis.

### BRIEF DESCRIPTION OF THE DRAWINGS

FIG. 1 is an isometric exploded partial top view of a rack mounted device 100 in an example embodiment of the invention.

FIG. 2 is an isometric top view of a latch 102 in an example embodiment of the invention.

FIG. 3 is a top view of a latch 102 in an example embodiment of the invention.

### DETAILED DESCRIPTION

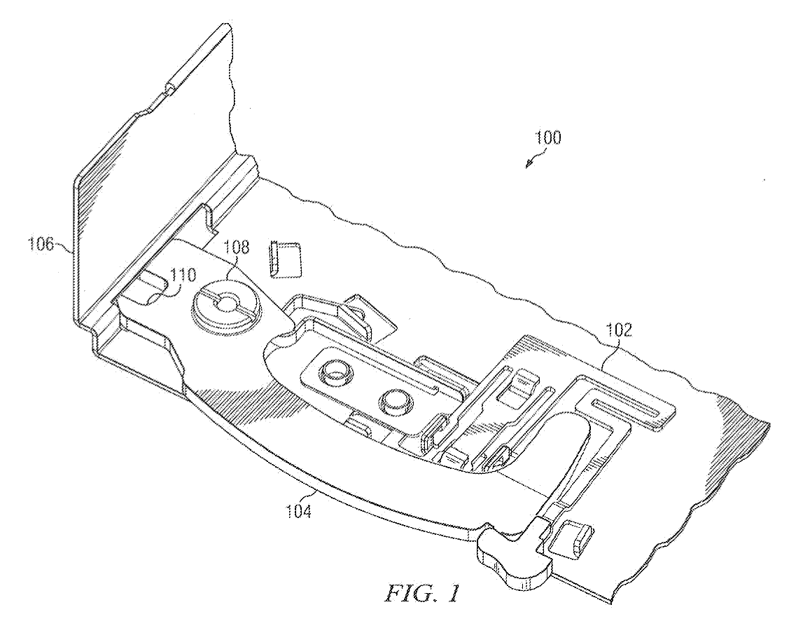

FIGS. 1-3, and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is an isometric exploded partial top view of a rack mounted device 100 in an example embodiment of the invention. Rack mounted device 100 comprises frame 106, insertion/removal handle 104, shoulder screw 108 and latch 102. Insertion/removal handle 104 is rotatably mounted onto frame using shoulder screw 108 and configured to rotate from an open position into a closed and latched position. Latch 102 is mounted into frame 106 adjacent to insertion/removal handle 104. Insertion/removal handle 104 is shown in the closed and latched position. Latch 102 snaps over the end of insertion/removal handle 104 and holds insertion/removal handle 104 in the closed position.

In operation, as insertion/removal handle 104 is rotated from the open position into the closed position, slot 110 mates with a tab in the rack or chassis and forces rack mounted device into the rack or chassis. Once insertion/removal handle 104 reaches the closed position, latch 102 snaps over the end of insertion/removal handle 104 and holds insertion/removal handle 104 in the closed position. To remove the rack mounted device from the rack, latch is deflected off the end of the insertion/removal handle 104 and then the insertion/removal handle 104 is rotated into the open position. As the insertion/removal handle 104 is rotated into the open position, slot forces the rack mounted device 100 out of the rack or chassis. Typically the rack mounted device will have two insertion/removal handle assemblies, one on each side of the rack mounted device 100.

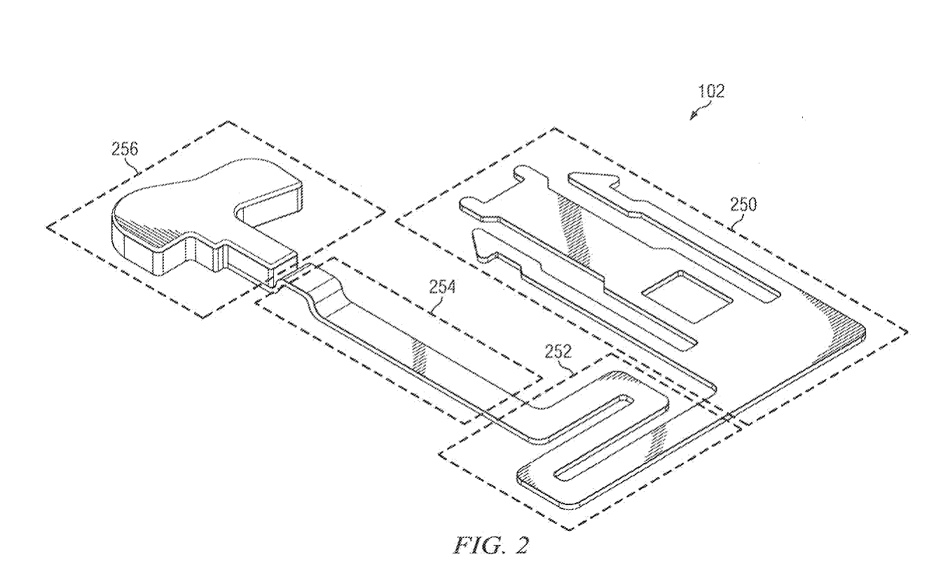

FIG. 2 is an isometric top view of a latch 102 in an example embodiment of the invention. Latch is fabricated from an essentially flat metal plate. The flat metal plate is typically 1 mm thick, but may be between 0.5 and 2 mm thick. In one example embodiment the metal used is spring or stainless steel sheet metal, for example series 301. The flat metal plate is divided into a number of sections. Latch 102 comprises an attachment section 250, a serpentine section 252, a beam section 254 and a head section 256. All features of the attachment section, the serpentine section 252 and the beam section 254 remain in the plane of the metal plate. The head section has an area of the plate that is bent out of the plane of rest of the latch. In addition, the head section has a catch molded onto the metal plate. The catch may be fabricated from plastic. The catch may extend out of the plane of the flat plate.

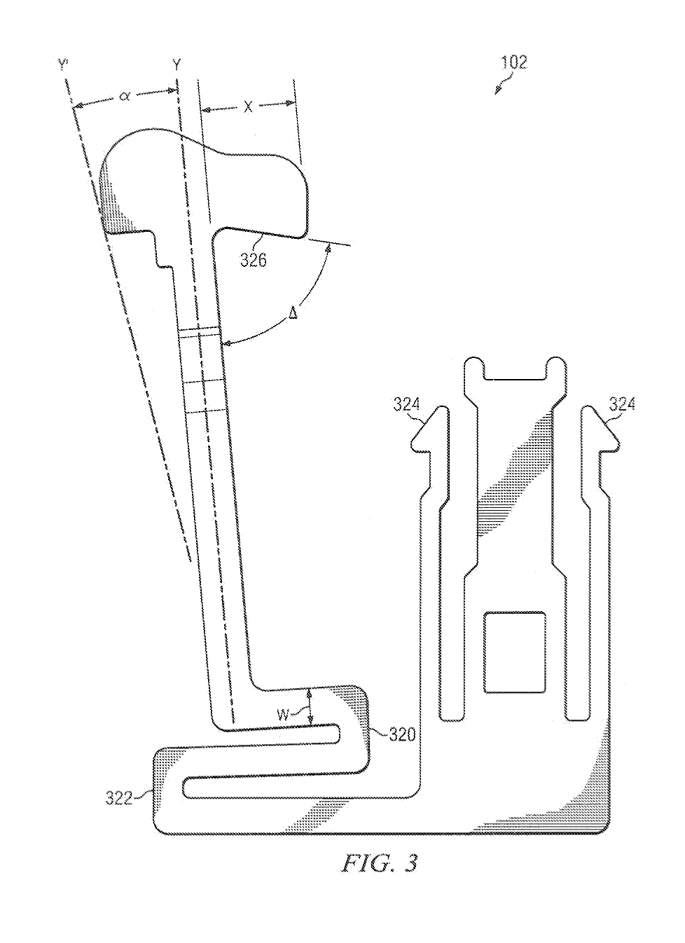

FIG. 3 is a top view of a latch 102 in an example embodiment of the invention. The attachment section of latch 102 (section 250 in FIG. 2) is configured to snap into and hold the latch into a rack mounted device. The attachment section of the latch is configured to be slid into the rack mounted device. As the attachment section is slid into the rack mounted device the two cantilevered tabs 324 snap into mating cavities in the rack mounted device to hold the latch in place (see FIG. 1). In other example embodiments, attachment section may use other fastening techniques to hold latch into the rack mounted device, for example one or more screws.

The serpentine section of latch 102 (section 252 in FIG. 2) is adjacent to the attachment section. The serpentine section has two 180 degree bends (320 and 322). Both bends arc in the plane of the metal plate (i.e. in the plane of the drawing/paper). The serpentine section 252 has an average width W. In some example embodiments of the invention W is between 2 and 2.5 mm, or about 2 to 2.5 times the thickness of the latch. In other example embodiments, W may be between 1.5 and 3.5 mm or between 1.5 and 3.5 times the thickness of the plate. The beam section (section 254 in FIG. 2) extends at an angle from the serpentine section. The beam section is a straight section of the plate. A head is attached to the beam at the opposite end from the serpentine section. The head section may be fabricated from plastic molded onto the metal plate. The head section has a catch 326 that extends from the edge of the beam by a distance X. The catch forms an angle delta Δ from the edge of the beam. In some example embodiments of the invention angle delta is between 65 degrees and 84 degrees. Catch 326 snaps over a mating feature in a rack and holds the rack mounted device into the rack.

In operation, the serpentine section 252 allows the head to be deflected by distance X such that the rack mounted device can be removed from the rack. Distance X is typically 6 mm but may be between 3 and 10 mm. Beam section 254 forms an axis Y. When head section is displaced by distance X, beam is displaced to axis Y′. The deflection in the serpentine section 252 is concentrated in the two 180 degree bends (320 and 322). Bend 320 is put in compression and bend 322 is put in expansion. More of the deflection occurs in bend 322 than in bend 320. The deflection in the serpentine section of the latch occurs in the plane of the flat plate and does not occur perpendicular to the plane of the flat plate. Serpentine section 252 allows the displacement from axis Y to axis Y′, but remains stiff along axis Y. In some example embodiments of the invention, latch 102 is 10 times stiffer along axis Y than the conventional plastic latch it replaces.

What is claimed is:

1. A latch for a rack mounted device, comprising:
a flat plate formed from metal having a thickness T, the flat plate formed into a number of sections comprising:
an attachment section to attach the latch to the rack mounted device, the attachment section formed at one end of the flat plate;
a serpentine section formed adjacent to the attachment section, the serpentine section having an average width W where W is greater than T;
a beam extending at an angle from the serpentine section;
a head attached to the beam at the opposite end from the serpentine section, the head having a catch that extends from an edge of the beam by a distance X where X is in the plane of the flat plate, wherein the serpentine section is configured to bend in the plane of the flat plate to allow the catch to displace the distance X.

2. The latch for a rack mounted device of claim 1, wherein the serpentine section has at least two 180 degree bends and the bending of the serpentine section is concentrated in the at least two 180 degree bends.

3. The latch for a rack mounted device of claim 1, wherein W is at least 2 times T.

4. The latch for a rack mounted device of claim 1, wherein thickness T of the plate is between 0.5 mm and 1.5 mm.

5. The latch for a rack mounted device of claim 1, wherein distance X is at least 5 mm.

6. The latch for a rack mounted device of claim 1, wherein the attachment section has two cantilevered tabs that snap into cavities in the rack mounted device to lock the latch into the rack mounted device.

7. The latch for a rack mounted device of claim 1, wherein the flat metal plate is fabricated from stainless steel.

8. A rack mounted computer device, comprising:
a frame to hold computer components;
an insertion/removal handle mounted to the frame and configured to rotate between an open position and a closed position;
a latch attached to the frame at a first end of the latch, the latch positioned adjacent to one end of the insertion/removal handle, the latch formed from a flat plate having a thickness T, the latch comprising:
a serpentine section formed adjacent to the first end of the latch, the serpentine section having an average width W where W is greater than T;
a beam extending at an angle from the serpentine section;
a head attached to the beam at the opposite end from the serpentine section, the head having a catch that extends from an edge of the beam by a distance X in the plane of the flat plate, wherein the serpentine section is configured to bend in the plane of the flat plate to allow the catch to displace the distance X thereby snapping over the end of the insertion/removal handle and holding the insertion/removal handle in the closed position.

9. The rack mounted computer device of claim 8, wherein the serpentine section has at least two 180 degree bends and the bending of the serpentine section is concentrated in the at least two 180 degree bends.

10. The rack mounted computer device of claim 8, wherein W is at least 2 times T.

11. The rack mounted computer device of claim 8, wherein the attachment section has two cantilevered tabs that snap into cavities in the rack mounted device to lock the latch into the rack mounted device.

12. The rack mounted computer device of claim 8, wherein the flat metal plate is fabricated from stainless steel.

13. A latch for a rack mounted device, comprising:
a flat plate having a thickness T, the flat plate fabricated from metal, the flat plate comprising:
a means for attaching the latch to the rack mounted device, the means for attaching formed at one end of the flat metal plate;
a means for deflecting a beam section of the flat plate from a first position to a second position, the deflection being in the plane of the flat plate, the means for deflecting positioned between the means for attaching and the beam;
a head, attached to the beam at the opposite end from the means for deflecting, the head having a catch that extends from an edge of the beam by a distance X, wherein the catch is displaced by the distance X when the beam is deflected from the first position to the second position.
